(19) United States
(12) Patent Application Publication
(10) Pub. No.: US 2025/0039320 A1
(43) Pub. Date: Jan. 30, 2025

(54) IMAGE FORMING APPARATUS AND PROCESS EXECUTING METHOD

(71) Applicant: SHARP KABUSHIKI KAISHA, Osaka (JP)

(72) Inventors: YUICHI NISHII, Osaka (JP); SHOJI NODA, Osaka (JP)

(21) Appl. No.: 18/778,958

(22) Filed: Jul. 20, 2024

(30) Foreign Application Priority Data
Jul. 26, 2023 (JP) 2023-121979
Jul. 26, 2023 (JP) 2023-121980

(51) Int. Cl. H04N 1/32; G06F 21/60; H04N 1/00

(52) U.S. Cl. CPC H04N 1/32096; G06F 21/608; H04N 1/00217

(57) ABSTRACT

An image forming apparatus, includes one or more memories that store user information including destination information associated with one or more users, an authenticator that authenticates a login of any one of the one or more users with reference to the user information, an acquirer that acquires the destination information associated with the logged-in user, and one or more controllers that are capable of executing a transmission process with the destination information as a transmission destination when the destination information associated with the logged-in user is obtained from the user information. The one or more controllers execute, even when the destination information associated with the logged-in user is not acquired from the user information, the transmission process by accepting a setting of the transmission destination performed by the logged-in user.

### BACKGROUND OF THE INVENTION

### Field of the Invention

The present disclosure relates to an image forming apparatus and the like. The present application is based on Japanese Patent Application Nos. 2023-121979 and 2023-121980 filed in Japan on Jul. 26, 2023, and the entire contents thereof are included in the present application.

### Description of the Background Art

For example, a technique for acquiring, when authentication of a user is successfully performed in user authentication, transmission destination information associated with a user and transmitting an image based on the transmission destination information is known.

An object of the present disclosure is to provide an image forming apparatus and the like capable of executing an image transmission process irrespective of acquisition of destination information, for example.

### SUMMARY OF THE INVENTION

An image forming apparatus according to a present disclosure includes one or more memories that store user information including destination information associated with one or more users, an authenticator that authenticates a login of any one of the one or more users with reference to the user information, an acquirer that acquires the destination information associated with the logged-in user, and one or more controllers that are capable of executing a transmission process with the acquired destination information as a transmission destination when the destination information associated with the logged-in user is obtained from the user information. The one or more controllers execute, even when the destination information associated with the logged-in user is not acquired from the user information, the transmission process by accepting a setting of the transmission destination performed by the logged-in user.

A process executing method according to the present disclosure, includes storing user information including destination information associated with one or more users, authenticating a login of any one of the one or more users with reference to the user information, acquiring the destination information associated with the logged-in user from the user information, and by accepting a setting of a transmission destination from the logged-in user, executing a transmission process with respect to the transmission destination, even when the destination information associated with the logged-in user is not acquired from the user information.

According to the present disclosure, an image forming apparatus and the like capable of executing an image transmission process irrespective of acquisition of destination information may be provided.

### BRIEF DESCRIPTION OF THE DRAWINGS

FIG. 1 is a diagram illustrating an outline of a system according to a first embodiment.

FIG. 2 is a diagram illustrating a hardware configuration of an image forming apparatus according to the first embodiment.

FIG. 3 is a diagram illustrating a software configuration according to the first embodiment.

FIG. 4A is a diagram illustrating an example of a system setting according to the first embodiment.

FIG. 4B is a diagram illustrating an example of user information according to the first embodiment.

FIG. 5 is a diagram illustrating an example of a system setting screen according to the first embodiment.

FIG. 6 is a flowchart of an operation of a main process according to the first embodiment.

FIG. 7 is a diagram illustrating an example of a job setting screen according to the first embodiment.

FIG. 8 is a flowchart of an operation of a job process according to the first embodiment.

FIG. 9 is a diagram illustrating an example of a job execution screen according to the first embodiment.

FIG. 10 is a diagram illustrating an example of a job execution screen according to the first embodiment.

FIG. 11 is a flowchart of an operation of a job process according to a second embodiment.

FIG. 12 is a diagram illustrating an example of a system setting screen according to the second embodiment.

FIG. 13 is a diagram illustrating an example of a job execution screen according to the second embodiment.

FIG. 14 is a diagram illustrating an example of a job execution screen according to the second embodiment.

FIG. 15 is a diagram illustrating an example of an address book screen according to the second embodiment.

FIG. 16 is a flowchart of an operation of a job process according to a third embodiment.

FIG. 17 is a diagram illustrating an example of a job execution screen according to the third embodiment.

FIG. 18 is a flowchart of an operation of a job process according to a fourth embodiment.

FIG. 19 is a flowchart of an operation of a job process according to a fifth embodiment.

FIG. 20 is a diagram illustrating an example of a system setting screen according to the fifth embodiment.

FIG. 21 is a diagram illustrating an example of a permission screen according to the fifth embodiment.

FIG. 22 is a diagram illustrating an example of a password input screen according to the fifth embodiment.

FIG. 23 is a diagram illustrating an example of a permission screen according to the fifth embodiment.

FIG. 24 is a flowchart of an operation of a job process according to a sixth embodiment.

FIG. 25 is a diagram illustrating an example of a destination confirmation screen according to a seventh embodiment.

### DESCRIPTION OF THE PREFERRED EMBODIMENTS

Hereinafter, embodiments of the present disclosure will be described with reference to the accompanying drawings. Note that the embodiments below are merely examples of the present disclosure, and the content of the present disclosure is not to be construed as limited based on the following description.

Image forming apparatuses are capable of executing various processes, such as an image transmission process (scan process) of transmitting image data based on a scanned image to a desired E-mail address or a folder (directory).

Furthermore, the image forming apparatuses have various functions for improving usability and security when a user executes the image transmission process (scan process).

For example, in the image transmission process of the image forming apparatus, a user is required to select a destination which is a transmission destination of image data in each transmission.

Therefore, some of the image forming apparatuses have a function referred to as a “default destination function”, for example, so that the user is not required to select a destination in each transmission. In the default destination function, a destination of an initial setting (default) is set in advance, and image data is transmitted to the default destination.

In this way, the default destination function automatically determines a transmission destination of image data based on content set by the system. Use of the default destination function in the image forming apparatus provides the following advantages.

(1) Since a destination is set in advance, the user is not required to input the destination in each transmission. For example, when image data based on an image scanned using the scan process is transmitted as a part of the image transmission process, the image data is often transmitted to an E-mail address of the user or a shared directory used by the user. Therefore, by setting the E-mail address of the logged-in user or a home directory of the logged-in user as the default destination in advance, the scan process may be executed without selection of a destination performed by the user in each transmission.

(2) A transmission destination is limited only to a destination set in advance. An image forming apparatus 10 can prevent erroneous transmission by the user by limiting a transmission destination. Furthermore, since the user may not transmit image data to a destination other than the destination set in advance, leakage of information can be suppressed.

In this way, the default destination function is highly useful for the user. However, in order to use the default destination function, a setting of destination information is required as information about a destination for the logged-in user. The destination information may include, for example, an E-mail address of the logged-in user and a folder path of the shared directory. The destination information may further include, for example, information about an SNS account of the logged-in user.

Therefore, when destination information has not been set for the logged-in user, a transmission destination may not be specified. Furthermore, in general, destination information is set for a logged-in user, but a temporary user (for example, a guest, a temporary staff member, or an irregular staff member) is treated as a user who does not have transmission authority. In this case, since user information (destination information) is not stored for the user who has logged in, the user may not use the scan process.

Accordingly, when a user (who does not have authority, such as a temporary staff member, a part-time staff member, or an office clerk, for example) who has information about a destination allocated thereto desires to execute a process of transmitting image data, a dummy address is required to be registered in user information. Then, after the process of transmitting the image data is executed, the dummy address is deleted from the user information, which is a troublesome operation.

In order to solve these problems, in the following embodiments, image forming apparatuses having an image transmission function to be used irrespective of acquisition of destination information will be described.

### 1. First Embodiment

### 1.1 Entire System

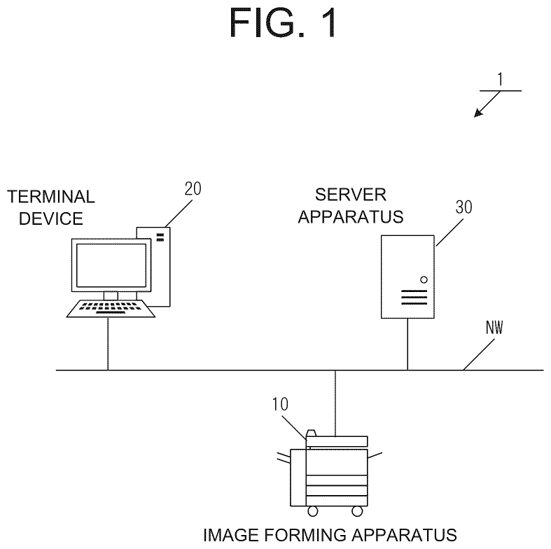

FIG. 1 is a diagram illustrating an outline of a system 1.

The system 1 includes an image forming apparatus 10, a terminal device 20 capable of communicating with the image forming apparatus 10 through a network NW, and a server apparatus 30.

The image forming apparatus 10 is referred to as a Multifunction Peripheral/Printer/Product (MFP), for example. For example, when executing a job (a print job), the image forming apparatus 10 can form an image on a sheet, that is, a recording medium. The image forming apparatus 10 is capable of executing jobs of a plurality of processes including a copy process, a FAX process, a scan process, and a printer process serving as jobs to be executed.

The terminal device 20 is used by a user or an administrator. Specifically, the user transmits a print job from the terminal device 20 to the image forming apparatus 10. The image forming apparatus 10 executes the received print job so as to perform printing based on print data, for example. Furthermore, the administrator can perform settings of the image forming apparatus 10, for example, by accessing the image forming apparatus 10 from the terminal device 20.

The server apparatus 30 may manage user information, for example. The server apparatus 30 may collectively manage user information using Lightweight Directory Access Protocol (LDAP) service, for example.

The terminal device 20 and the server apparatus 30 are included in the system 1 as needed. For example, a single terminal device 20 may be included or a plurality of terminal devices 20 may be connected. Furthermore, the server apparatus 30 may use external services (including services provided on a cloud), for example.

Moreover, the network NW used to connect the image forming apparatus 10, the terminal device 20, and the server apparatus 30 to one another is any communication line or any communication system, and a communication system, such as a wired or wireless Local Area Network (LAN), the Internet, a public line network, mobile communication (such as 4G/5G/6G), or a next-generation telephone network, may be used.

### 1.2 Hardware Configuration

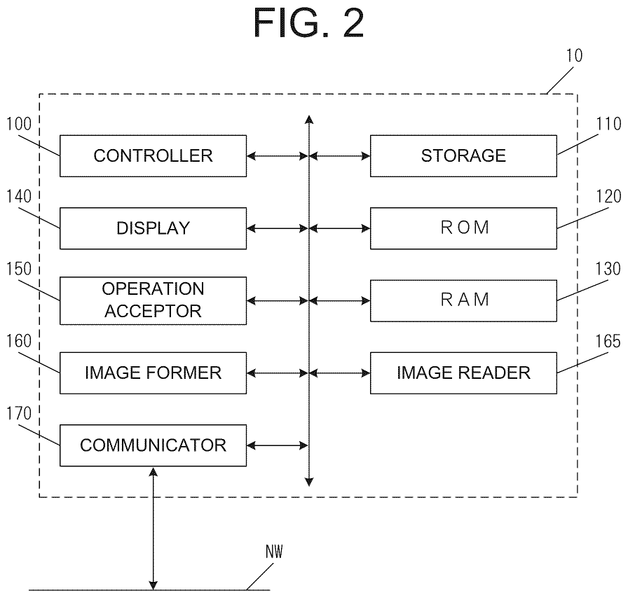

A hardware configuration of each of the apparatuses will be described below with reference to the drawings. FIG. 2 is a diagram illustrating an example of the image forming apparatus 10.

As illustrated in FIG. 2, the image forming apparatus 10 includes a controller 100, a storage 110, a Read Only Memory (ROM) 120, and a Random Access Memory (RAM) 130 that serve as storage devices (storage section), a display 140, an operation acceptor 150, an image former 160, an image reader 165, and a communicator 170.

The controller 100 controls the entire image forming apparatus 10. The controller 100 reads and executes various programs stored in the storage devices (including the storage 110 and the ROM 120) so as to realize various functions. The controller 100 may be realized by, for example, one or more control devices/computing devices (e.g., a Central Processing Unit (CPU) or a System on a Chip (SoC)). Alternatively, the controller 100 may be configured by a control circuit.

The storage 110 is a non-volatile storage device capable of storing programs and data. For example, the storage 110 may be configured by one or more storage devices, such as a Hard Disk Drive (HDD) or a Solid State Drive (SSD). Furthermore, the storage 110 may be configured by a Universal Serial Bus (USB) memory which is connectable to an outside. Alternatively, the storage 110 may be, for example, a storage region on a cloud.

The ROM 120 is a non-volatile memory capable of retaining programs and data even when power is turned off.

The RAM 130 is a main memory mainly used when the controller 100 executes processing. The RAM 130 is a rewritable memory that temporarily stores programs read from the storage 110 or the ROM 120 and data including results of execution.

The display 140 is a display device capable of displaying various pieces of information and execution screens. The display 140 may be, for example, a display device, such as a liquid crystal display (LCD), an organic Electro Luminescence (EL) display, or an electrophoretic display. Furthermore, the display 140 includes an interface to which a display device is connectable. For example, the display 140 may be configured by an external display device connected via High-Definition Multimedia Interface (HDMI) (registered trademark), Digital Visual Interface (DVI), or Display Port.

The operation acceptor 150 is an operation device that allows a user to input an operation. For example, the operation acceptor 150 may be an operation device, such as a touch panel integrated with the display 140 or an operation button. Furthermore, the operation acceptor 150 may be an operation device, such as a keyboard or a mouse. Moreover, the operation acceptor 150 may include an interface (e.g., Universal Serial Bus (USB)) to which an operation device is connectable. For example, the image forming apparatus 10 may be connected to a different operation device (an operation device with a touch panel).

The image former 160 forms an image, for example, on a recording sheet. The image former 160, for example, includes an image carrier, forms a toner image on the image carrier, and transfers the image on the image carrier onto a recording sheet, thereby forming an image. The image former 160 may be configured as an image forming apparatus, such as a printer. Furthermore, the image former 160 may electronically form an image as an image file.

The image reader 165 reads a document (image) to be output as image data. The image reader 165 is, for example, a scanner, and may be a reading device using a Charge Coupled Device (CCD) or a Contact Image Sensor (CIS).

The communicator 170 is a communication interface used to communicate with other devices. For example, the communicator 170 may be a network interface capable of providing a wired connection or a wireless connection. In this embodiment, communication with other devices is available via the network NW.

Note that the terminal device 20 and the server apparatus 30 may be general-purpose information processing apparatuses. For example, one or more functions of a controller, a storage section (storage, ROM, RAM), a display, an operation acceptor, a communicator, and the like are provided. Since the configurations of the terminal device 20 and the server apparatus 30 are apparent, detailed descriptions thereof are omitted.

### 1.3 Software Configuration

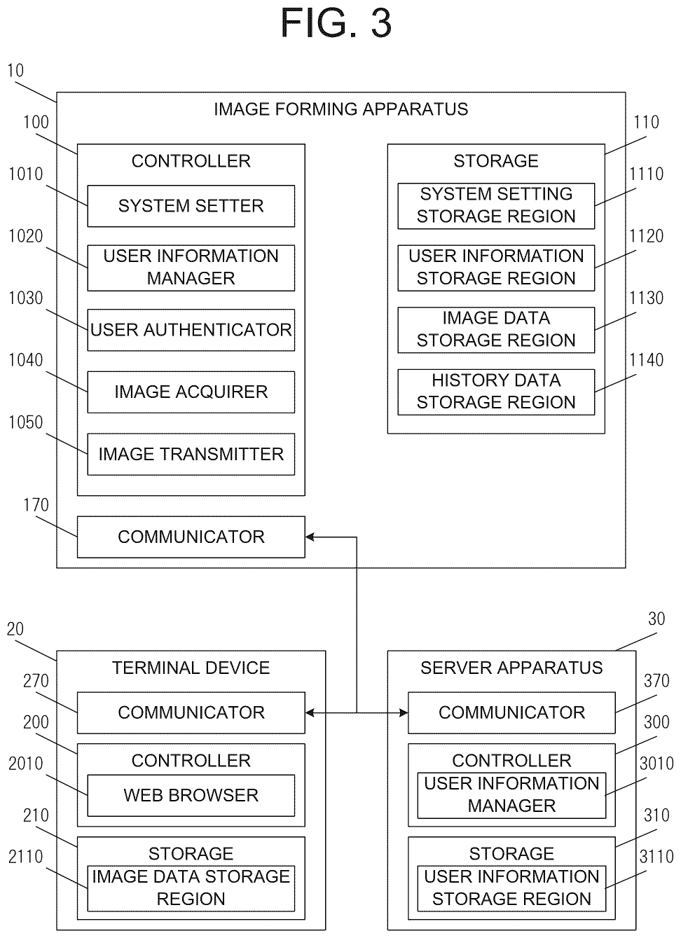

Main software configurations of the apparatuses of the system 1 will be described with reference to FIG. 3. FIG. 3 is a diagram illustrating main software configurations of the image forming apparatus 10, the terminal device 20, and the server apparatus 30. Note that the software configurations illustrated in FIG. 3 are main configurations required for this embodiment, and other configurations are omitted. For example, in a case of the image forming apparatus 10, configurations that provide functions required for the image forming apparatus 10, such as an image processor and a power controller, may be further included.

The controller 100 of the image forming apparatus 10 functions as the following configurations by executing programs (applications) stored in the storage 110 or the ROM 120.

A system setter 1010 performs settings of a system (hereinafter referred to as “system settings”) for operating the image forming apparatus 10. The system settings set by the system setter 1010 are stored in a system setting storage region 1110 of the storage 110.

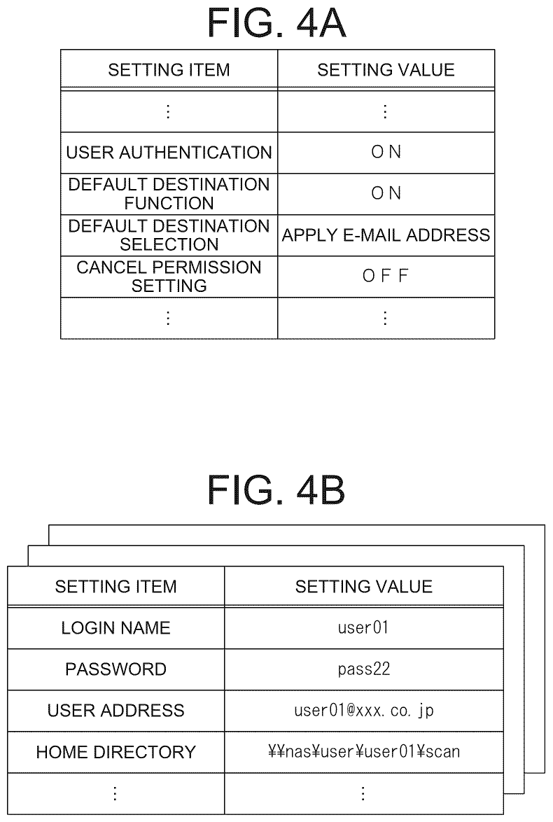

An example of the system settings stored in the system setting storage region 1110 is illustrated in FIG. 4A. The system setting storage region 1110 stores, for example, the following information as necessary.

User Authentication: This indicates a setting indicating whether a user authentication function is to be used. In a case of “ON”, the user is required to perform authentication to use the image forming apparatus 10. In a case of “OFF”, the user is not required to perform authentication when using the image forming apparatus 10. Furthermore, when the user authentication is “ON”, a setting as to whether use by a guest user is permitted may be made.

Default Destination Function: This indicates a setting indicating whether a default destination function is to be used. When the default destination function is “ON”, a destination of a setting item of a next default destination selection is set as the default destination.

Default Destination Setting: This indicates content of a setting as a default destination when the default destination function is “ON”. As the default destination, one of “an E-mail address set in the user information as destination information of a logged-in user”, “a home directory set in the user information as destination information of a logged-in user”, and “an E-mail address or a directory selected from an address book” may be selected.

Cancel Permission Setting: This indicates whether an address set as a default destination may be canceled. When the cancel permission setting is “ON”, the user may cancel the default destination and input a destination desired by the user. When the cancel permission setting is “OFF”, the user may not cancel the default destination. That is, the user may not transmit image data to a destination other than the default destination.

Note that the content of the system settings illustrated in FIG. 4A is a merely example. Other settings may be stored as the system settings, and unrequired settings in the settings in FIG. 4A may not be stored.

A user information manager 1020 manages the user information. For example, the user information may be newly registered, or the registered user information may be changed, updated, or deleted. The user information manager 1020 stores the user information in a user information storage region 1120. Here, the user information may be available as an address book, for example. The user may select a destination serving as a transmission destination by using the address book.

An example of the user information stored in the user information storage region 1120 is illustrated in FIG. 4B. The user information storage region 1120 stores, for example, a login name (e.g., “user01”) and a password (e.g., “pass22”) as the user information. In addition, a user address (e.g., “user01@xxx.co.jp”) and a home directory (e.g., “¥¥nas¥user¥user01¥scan”) of the user are stored as destination information relating to the user. The destination information may include, in addition to the user address and the home directory, for example, an account of an SNS, a telephone number, a FAX number, or the like as a destination.

A user authenticator 1030 executes user authentication. For example, the user authentication may be performed using a user ID and a password. In addition, the user authenticator 1030 may perform user authentication using a device, such as a user authentication card, or may perform biometric authentication using a fingerprint, an iris, or a retina.

An image acquirer 1040 acquires an image. For example, when the scan process (scan job) is executed, the image forming apparatus 10 reads an image from the image reader 162 so as to acquire image data. Alternatively, the image data output by the image reader 162 may be stored in the image data storage region 1130.

An image transmitter 1050 transmits image data to another apparatus through the communicator 170. When transmitting image data through an E-mail, the image transmitter 1050 transmits the E-mail to which the image data is attached to a mail server (SMTP server). Furthermore, when transmitting image data to a directory, for example, the image transmitter 1050 transmits the image data to a shared directory or a user directory. When the image data storage region 1130 stores image data, the image transmitter 1050 reads the image data from the image data storage region 1130 before transmitting the image data. Here, the directory is a place where data is stored, and may be referred to as a folder.

A history data storage region 1140 stores data on history of various data and various information and data on a log. For example, the history data may be a log of a job in which image data has been transmitted. Alternatively, the history data may be stored as history of destinations of transmission of the image transmitter 1050. Furthermore, the history data may be a log of destination information acquired by the controller 100, for example.

The terminal device 20 may transmit image data to the image forming apparatus 10. For example, a controller 200 of the terminal device 20 transmits image data stored in an image data storage region 2110 of a storage 210 to the image forming apparatus 10 through a communicator 270. The image forming apparatus 10 receives the image data through the communicator 170 and stores the image data in the image data storage region 1130.

Furthermore, the terminal device 20 may perform a system setting on the image forming apparatus 10. For example, the system setter 1010 of the image forming apparatus 10 provides a user interface for setting the system as a WEB screen. The terminal device 20 may cause the WEB browser 2010 to display the WEB screen and the system setting may be performed when the user operates the WEB screen.

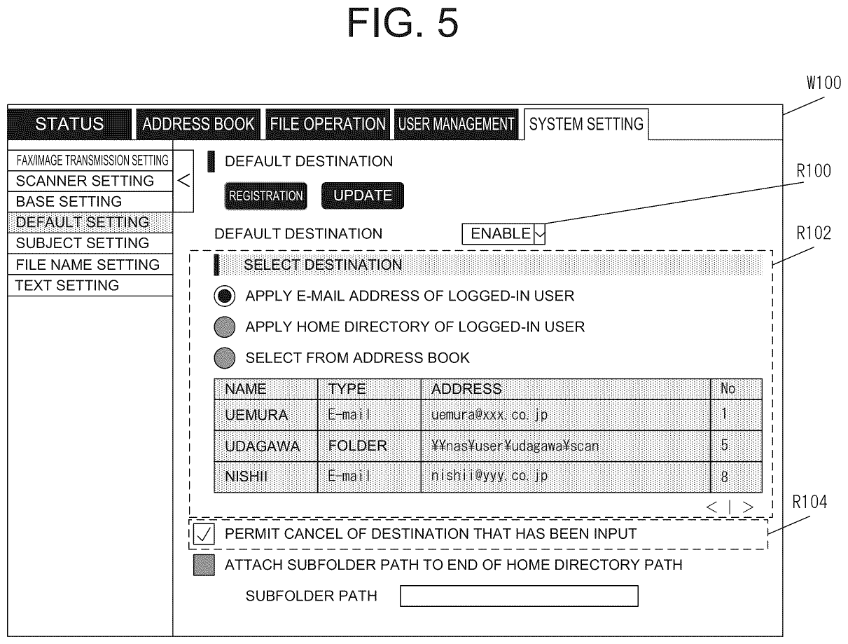

FIG. 5 is a diagram illustrating an example of a system setting screen W100 indicating a user interface for performing the system setting, for example. The system setting screen W100 may be displayed in the terminal device 20 or the image forming apparatus 10.

For example, in the system setting screen W100, a setting of enabling or disabling (ON/OFF) of a default destination function may be performed in a region R100. Furthermore, a region R102 is used to set items required for the default destination function. In FIG. 5, use of destination information set for the logged-in user is selected, and use of an E-mail address is set in the destination information.

Furthermore, settings in the default destination function may be further performed in the system setting screen W100. For example, in a region R104, an item for setting the cancel permission setting described above is displayed. For example, the cancel permission setting is enabled by checking the function of the region R104. The cancel permission setting will be described in detail in an embodiment described below.

The server apparatus 30 provides an LDAP service, for example. Specifically, the controller 300 of the server apparatus 30 may execute a user information manager 3010 to generate, update, and delete user information in a user information storage region 3110 stored in a storage 310.

The user information manager 1020 of the image forming apparatus 10 acquires the user information from the user information manager 3010 of the server apparatus 30. Furthermore, the image forming apparatus 10 may set whether the user information stored in the storage 110 of the image forming apparatus 10 is to be acquired or the user information managed by the server apparatus 30 is to be acquired.

### 1.4 Processing Flow

Hereinafter, a processing flow of this embodiment will be described with reference to the accompanying drawings. Note that the following processing will be described focusing on points that clarify features of the present disclosure.

### 1.4.1 Main Process

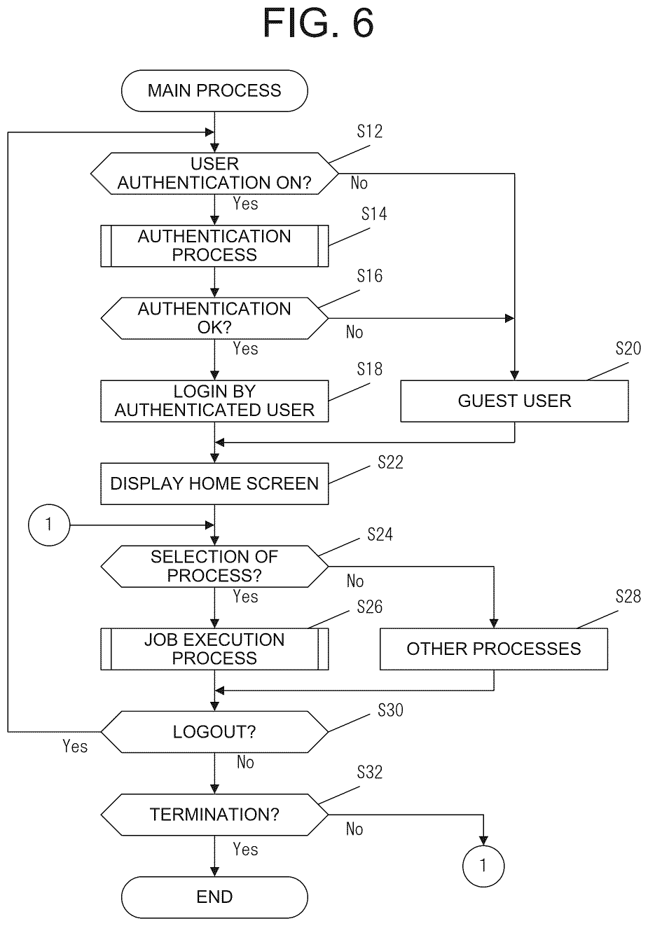

FIG. 6 is a flowchart illustrating an operation of a main process. The controller 100 determines whether the user authentication function is enabled. When the user authentication function is “ON” (step S12; Yes), the controller 300 executes an authentication process (step S14). As the authentication process, the user authenticator 1030 executes a process associated with the user authentication.

Here, when the authentication process is appropriately executed and the user authentication is successfully performed (step S16; Yes), login is performed by the authenticated user (step S18). On the other hand, when the user authentication function is “OFF” and is in a state of not being used, and when use by a guest user is permitted, the user uses the image forming apparatus 10 as a guest (step S12; No→step S20). Furthermore, when the user authenticator 1030 does not successfully execute the user authentication in step S14, the process in step S20 is executed (step S16; No→step S20).

Here, in step S20, when the image forming apparatus 10 accepts the guest user, the process is continued while the user information is “Guest”. When the user is a guest user, the image forming apparatus 10 may impose restrictions on executable processes and settable contents.

Furthermore, when the image forming apparatus 10 does not accept login of the guest user, the process from step S12 may be repeatedly performed or this process may be terminated.

When the user logs in, the controller 100 displays a home screen which is an example of an initial screen (step S22). The home screen is used by the user to select a process executable by the image forming apparatus 10. When the user selects a process on the home screen, the controller 100 performs a job execution process based on the selection (step S24; Yes→step S26).

Furthermore, when a process other than the job execution is selected, the controller 100 executes other processes (step S28). The other processes may be a system setting process and a history display process which do not directly relate to the job execution.

Here, when the user performs the logout process, the controller 100 causes the user who is currently logged in to log out and executes the process in step S12 again (step S30; Yes→step S12).

Furthermore, the controller 100 repeatedly executes the process from step S24 while a process of terminating the system, such as shutdown, is not executed, for example (step S32; No→step S24).

Furthermore, the controller 100 terminates the process in FIG. 6 (step S32; Yes), when the process of terminating the system, such as shutdown, is executed.

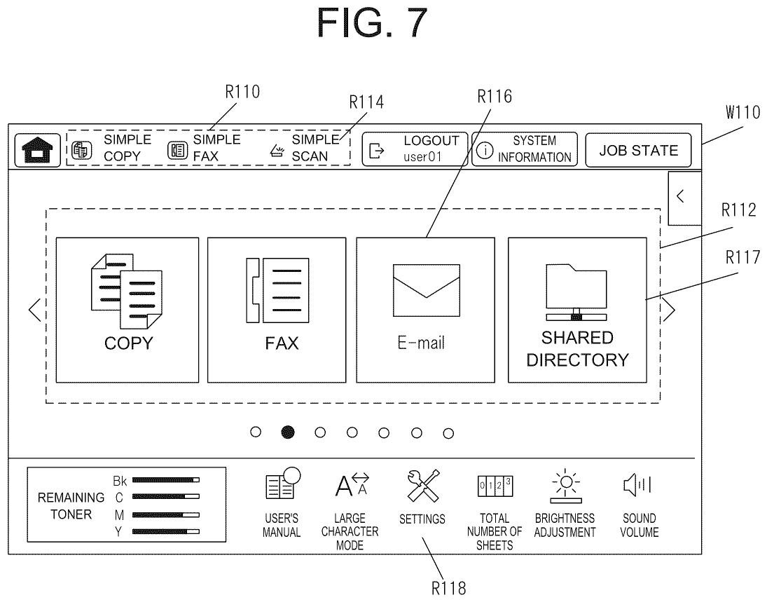

FIG. 7 is a diagram illustrating an example of a home screen W110 displayed in step S22 of FIG. 6. The image forming apparatus 10 displays the home screen W110. In the home screen W110, job execution processes are displayed in the regions R110 and R112. The regions R110 and R112 individually display buttons for selecting the corresponding job execution processes. For example, since the region R110 is displayed even when the screen is switched from the home screen, the corresponding processes may be easily selected in the region R110. Furthermore, the region R112 includes buttons displayed on the home screen W110, and the plurality of buttons may be displayed by shifting the region R112 to the left and right.

Furthermore, buttons for executing other processes than the job execution processes may be displayed on a lower side in the home screen W110. For example, when a region R117 is selected, the screen transitions to a system setting screen (for example, the system setting screen W100 in FIG. 5).

### 1.4.2 Job Execution Process

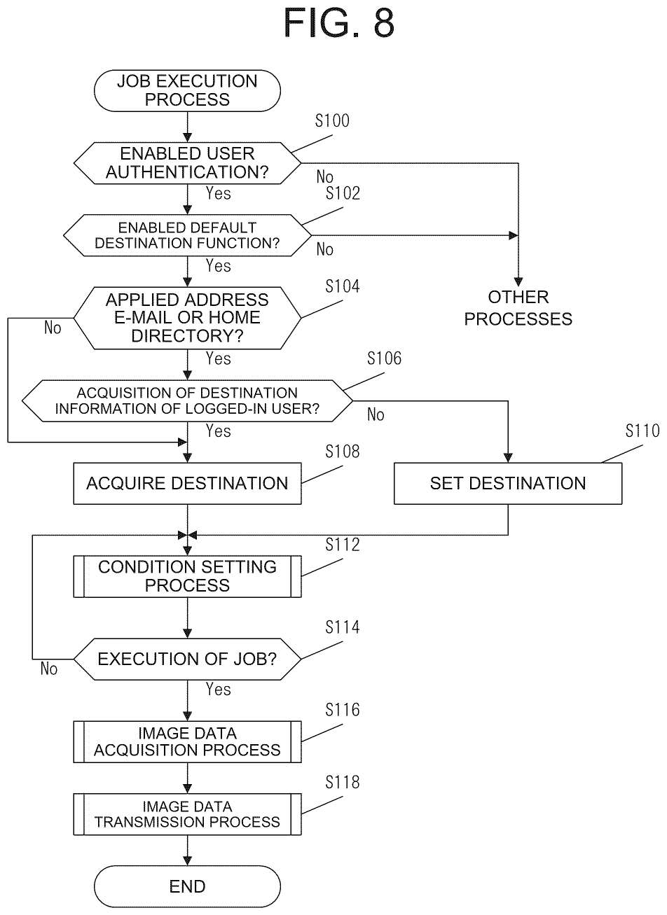

An operation performed when an image transmission process is executed as the job execution process will be described with reference to a flowchart of FIG. 8. Note that the process in FIG. 8 is executed when, for example, simple scan in a region R114, an E-mail in a region R116, or a shared directory in a region R117 are selected on the home screen in FIG. 7.

First, the controller 100 determines whether the user authentication function is enabled in the system setting (step S100). When the user authentication function is not enabled, other processes may be executed (step S100; No). Similarly, when the default destination function is not enabled, the controller 100 executes other processes (step S102; No).

Specifically, the process in FIG. 8 is executed when the user authentication is enabled and the default destination function is enabled (step S100; Yes→step S102; Yes).

When the default destination function is enabled, the controller 100 determines whether destination information of a logged-in user is to be referred to. Specifically, the controller 100 determines whether, as a setting for selection of an address as a default address, “Apply E-mail Address of Logged-in User” or “Apply Home Directory of Logged-in User” is enabled (step S104). That is, the controller 100 at least determines whether the default destination setting of the system setting stored in the system setting storage region 1110 is “Apply E-mail Address” or “Apply Home Directory”.

For example, when the destination information of the logged-in user is not required to be referred to, that is, when “Select from Address Book” is set as the default destination setting, the controller 100 acquires a specific destination set in the address book (step S104; No→step S108).

Here, it is set that the controller 100 refers to the destination information of the logged-in user, and when the destination information of the logged-in user can be obtained, the controller 100 acquires the destination information from the user information (step S104; Yes→step S106; Yes→step S108; Yes). Then the mail address or the home directory included in the destination information is set as the transmission destination in accordance with a job to be executed. Furthermore, the controller 100 acquires the destination information of the logged-in user from the user information of the logged-in user, for example.

When the controller 100 may not acquire the destination information of the logged-in user in step S106 (step S106; No), the controller 100 causes the user to set a destination (step S110).

Examples of the process of causing the user to set a destination performed by the controller include the following processes.

(1) The controller 100 accepts an input of a destination (for example, an E-mail address or a directory) performed by the user. For example, the user inputs information on a destination using a software keyboard, a hardware keyboard, the terminal device 20, and the like. Based on the input information, the controller 100 sets a destination as a transmission destination of image data when the controller 100 executes a job.

(2) The controller 100 accepts a selection of a destination in the address book. For example, the controller 100 reads user information in the address book or the like and displays a list of the user information. The controller 100 sets a destination selected by the user from candidates of the destination displayed as the list as a transmission destination of image data when the controller 100 executes the job.

Furthermore, a case where the destination information of the logged-in user may not be acquired may correspond to a case where the controller 100 may not set destination information since the destination information is not set in the user information, for example.

For example, in the user information illustrated in FIG. 4B, when an E-mail address is not set in a user address, the controller 100 may not acquire the destination information of the logged-in user. Furthermore, in the user information illustrated in FIG. 4B, when a home directory is not set, the controller 100 may not acquire the destination information of the logged-in user. Here, the controller 100 may determine whether both the two information pieces in the destination information have been set. Moreover, the controller 100 may determine whether destination information corresponding to a job to be currently executed has been set. For example, when image data is to be transmitted by an E-mail, the controller 100 determines whether an E-mail address has been set in the destination information.

The controller 100 executes a condition setting process (step S112). For example, the controller 100 can set conditions for reading an image (for example, setting of monochrome/color mode, setting of resolution, and the like). Furthermore, in the condition setting process, the controller 100 sets, for example, a condition for outputting image data (for example, a type of image data, such as a PDF format or a TIFF format). Note that, in FIG. 8, the controller 100 executes the condition setting process in step S112 after a destination is set in step S110 for convenience of the description. The controller 100 may set a destination (step S110) after executing the condition setting process (step S112), for example. Specifically, the controller 100 at least terminates settings of a destination and a job condition before the job is executed.

Subsequently, when an operation of the job execution is performed by the user, the controller 100 executes the job (step S114; Yes). In this embodiment, when the controller 100 executes the job, an image data acquisition process of acquiring image data is executed (step S116). Furthermore, the controller 100 executes a process of transmitting the acquired image data to a set destination by an E-mail or transmitting the image data to a set directory (step S118).

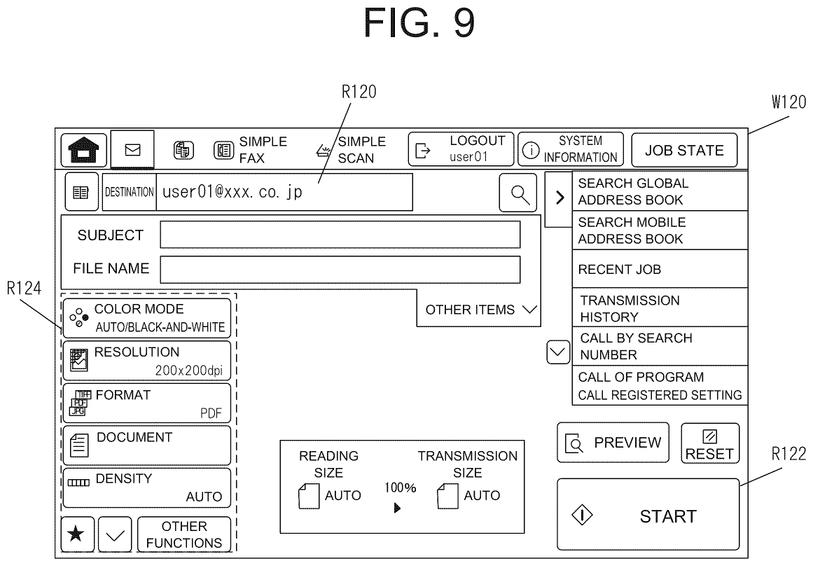

FIG. 9 is a diagram illustrating an example of a job execution screen W120 entered when the region R116 is selected in FIG. 7. The screen in FIG. 9 is displayed when the destination information is set in the user information. Specifically, the E-mail address or the home directory acquired from the destination information has been set as the destination in the region R120. Therefore, when a job execution key R122 is selected, the controller 100 reads an image, generates image data, attaches the image data to the E-mail, and transmits the attached image data to the destination displayed in the region R120.

Note that, in the region R124, condition settings are available. The user can set a condition for an image to be read and a condition for image data to be output using operation buttons displayed in the region R124 before the job execution.

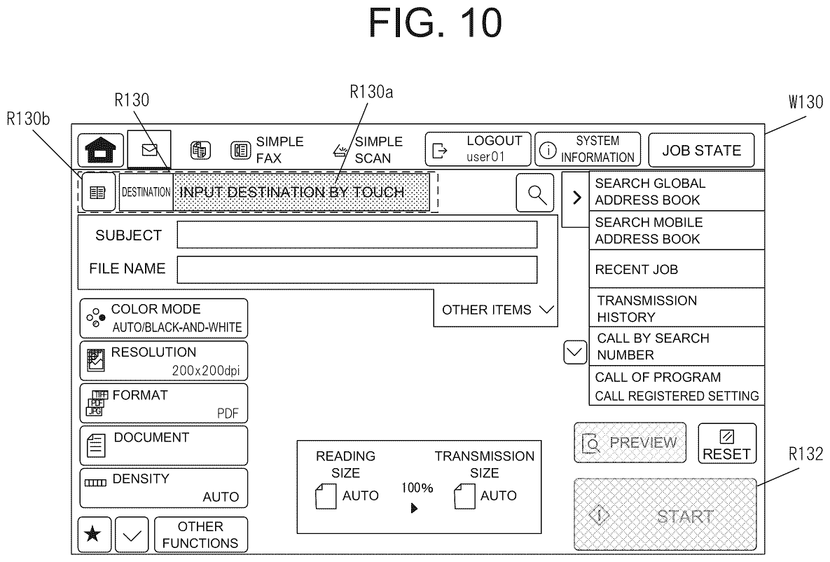

FIG. 10 is a diagram illustrating a job execution screen W130 displayed when destination information has not been set in the user information. The controller 100 may not acquire the destination information of the logged-in user, and therefore, a destination has not been set. For example, although a set destination is displayed in an input field R130a, a destination is not displayed because any destination has not been set in FIG. 10. At this time, the input field R130a may be displayed to prompt the user to input a destination. For example, the controller 100 may display a message “Input destination by touch” in the input field R130a.

The user can newly input destination information by selecting the region R130. Specifically, the controller 100 accepts an input of a destination performed by the user. For example, when the user selects the input field R130a, a destination (for example, an E-mail address serving as a destination) may be input. The controller 100 may display the software keyboard to accept an input performed by the user. Alternatively, the controller 100 may accept an input by an external keyboard when an external keyboard is connected. The user can thereby directly input at least one destination so as to set a destination.

Here, the direct input means an input of a destination directly performed by the user on an inputter (for example, a software keyboard displayed in the display 140, a hardware keyboard serving as an operation acceptor 150, or the like) by an input operation. For example, the user inputs an E-mail address and a directory name (folder name) by selecting at least one character displayed on the software keyboard.

Note that the direct input may include an input of a destination which is not stored in the address book (for example, user information stored in the user information storage region 1120 of the image forming apparatus 10, user information stored in the user information storage region 3110 of the server apparatus 30, and the like). For example, the direct input of the destination may include transmitting information on the destination from the terminal device 20 and setting the information as the destination.

In this way, an input of a destination other than destinations stored in the address book performed by the user is referred to as the “direct input”, and the direct input may be referred to as a free input.

Furthermore, when the user selects an address book button R130b, the controller 100 may display the address book. The user may select at least one destination from the address book and set the selected destination as a transmission destination.

Note that, when the destination has not been set, the controller 100 may not execute a job, and therefore, a process of not accepting a job execution key may be performed. For example, in FIG. 10, since a destination has not been set, the controller 100 displays a job execution key R132 in a non-selectable state.

Note that FIGS. 9 and 10 are diagrams illustrating job execution screens displayed when the region R116 is selected in FIG. 7. For example, in FIG. 7, when the region R117 is selected, not an E-mail address but information about a directory can be set as a destination.

### 1.5 Advantageous Effects

According to this embodiment, even when the destination information of the logged-in user may not be acquired, the user may set a destination serving as a transmission destination by inputting or selecting a destination and may execute processing relating to image transmission. As a result, the user can execute a job for transmitting an image without setting a dummy destination in the user information.

### 2. Second Embodiment

In a second embodiment, when destination information of a user may not be acquired, the user may set an address but the address setting is restricted.

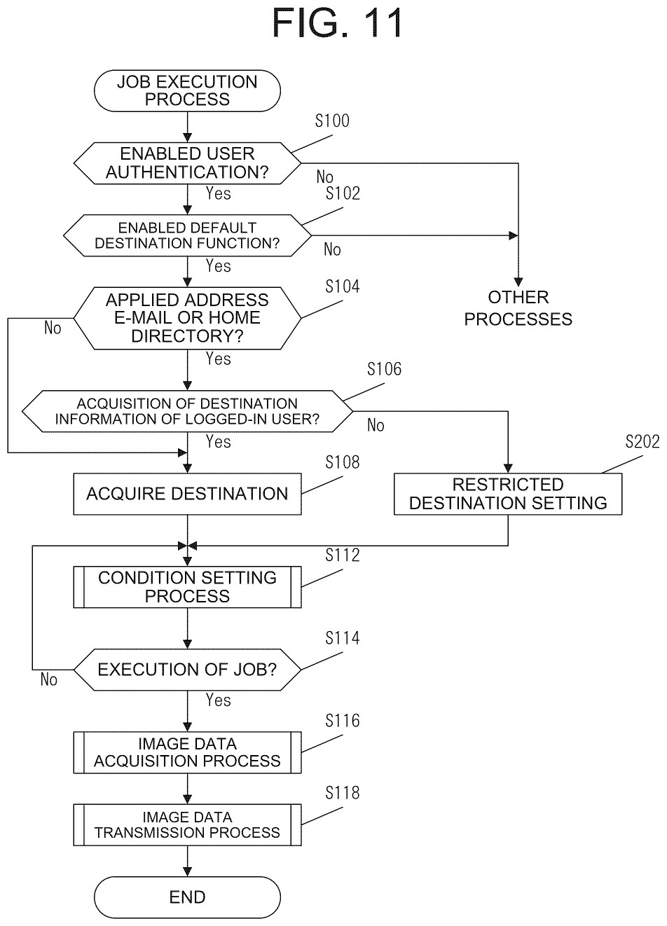

A hardware configuration and a software configuration of the second embodiment is the same as those of the first embodiment. In the second embodiment, a controller 100 executes a process in FIG. 11 instead of the process in FIG. 8 as a job execution process. Hereinafter, portions different from the first embodiment are mainly described, and other processes and configurations are substantially the same as those of the first embodiment.

As illustrated in FIG. 11, in the second embodiment, when destination information of a logged-in user may not be acquired in step S106, the controller 100 performs a restricted destination setting (step S202). Here, the restricted destination setting performed by the controller 100 may be as follows.

### (1) Prohibition of Direct Input (Prohibition of Acceptance of Input)

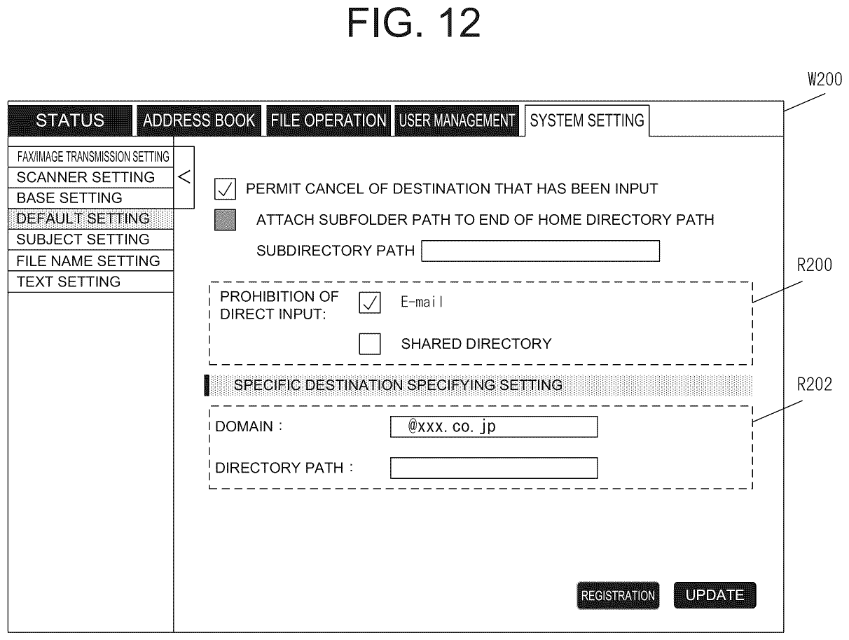

For example, a controller 200 prohibits a direct input of an address (or directory) performed by a user. FIG. 12 is an example of a system setting screen W200 displayed in an image forming apparatus 10 or a terminal device 20. Setting items displayed after the system setting screen W100 of FIG. 5 are illustrated.

For example, a setting item for setting prohibition of a direct input is displayed on a region R200. The controller 100 prohibits acceptance of an input of an E-mail address performed by a user, when “E-mail” is checked. Similarly, the controller 100 prohibits acceptance of an input of a directory (path, directory name, or the like) when “shared directory” is checked.

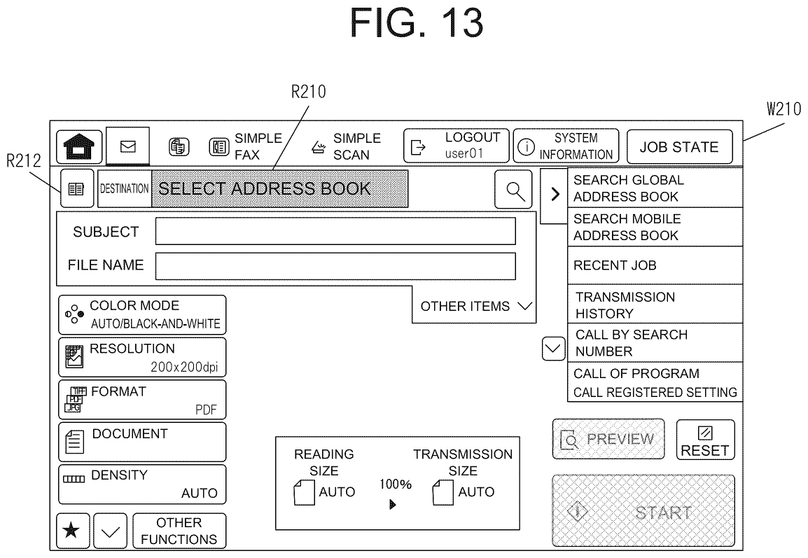

FIG. 13 is an example of a job execution screen W210 displayed in the image forming apparatus 10. Here, unlike the first embodiment, the user may not select a region R210. Furthermore, as illustrated in FIG. 13, the region R210 may be grayed-out so that the user can recognize that the region R210 is not selectable. Moreover, as illustrated in FIG. 13, a message “Select address book” may be displayed in the region R210. At this time, the user may not select the region R210 but selects an address book button of a region R212.

### (2) Only Specific Destination May be Input

For example, although the controller 100 accepts an input of an E-mail address (or directory) performed by the user, only E-mail addresses under a prescribed condition may be input.

For example, a setting of designation of a specific destination is available in a region R202 of the system setting screen W200. For example, when a domain is set, the controller 100 may accept an input of only an E-mail address including the set domain. Furthermore, when a path of a directory is set, the controller 100 may accept an input of only content including the set path of the directory.

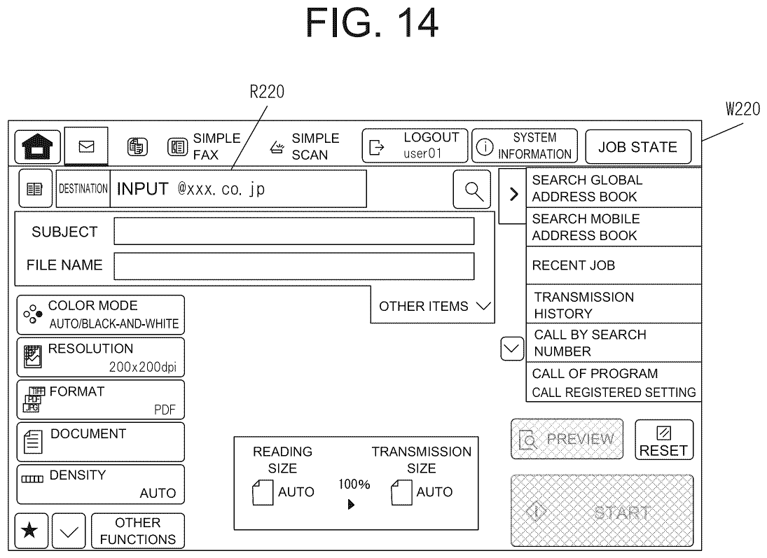

FIG. 14 is an example of a job execution screen W220 displayed in the image forming apparatus 10. Here, a region R220 is in a state in which the user can directly input a destination but a restriction is imposed. For example, as illustrated in FIG. 14, a domain name set on the system setting screen W200 is already displayed. The user may not change a domain portion, but may additionally input a character string before the domain portion. Note that the controller 100 may indicate to the user that the domain portion that may not be changed may not be changed by changing a color or the like.

### (3) Combination

(1) and (2) described above may be combined. For example, as illustrated in the system setting screen W200 of FIG. 12, prohibition of acceptance of a destination designated by the user is set and a domain name is set as a destination designation setting. The controller 100 prohibits the acceptance of an input of a destination and permits only a selection of a destination. Here, when the controller 100 further accepts the selection of a destination, the controller 100 may be configured not to accept a domain other than the domain set in the destination designation setting from the destinations included in the address book.

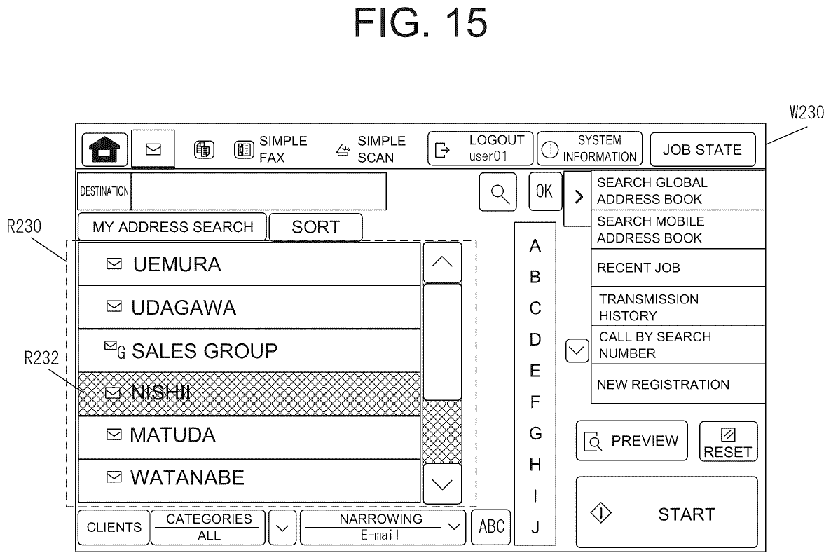

FIG. 15 is a diagram illustrating an example of an address book display screen W230. Here, the address book is information capable of storing a user name as a destination, an address corresponding to the user name, a shared directory name, a telephone number, and the like. In this embodiment, the address book is the same data as user information stored in the user information storage region 1120, but may be stored as separate data as an address book.

In the address book display screen W230, selectable addresses are displayed in a region R230 as a list. The region R230 displays a list of user names in the user information. By selecting one of the user names displayed in the region R230, the user can set a destination to which image data is to be transmitted based on destination information corresponding to the user name.

On the other hand, a user name is displayed in a region R232 in a non-selectable manner. Specifically, an E-mail address of the user in the region R232 has a domain other than the domain set in the destination designation setting. The region R232 is preferably displayed by a display mode different from that of the other users so that the non-selectable state is indicated for the user. For example, the region R232 may be displayed by gray-out or displayed in a color different from that of the other destinations. Alternatively, the region R232 may not be displayed. Furthermore, in the region R232, a color of a character string of a destination may be changed, or a character string indicating that a destination is not selectable may be added.

As described above, according to this embodiment, since restriction is imposed when the user sets a destination, a destination may be more flexibly set while security is ensured.

### 3. Third Embodiment

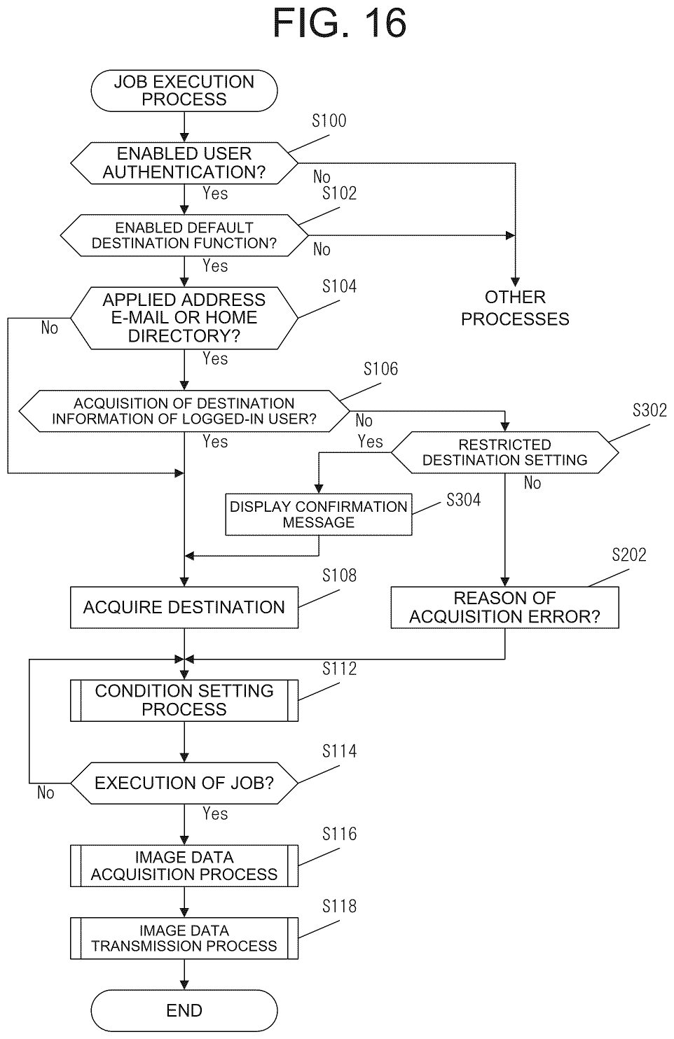

In a third embodiment, although destination information of a logged-in user is set, the destination information may not be acquired due to an error or the like. A hardware configuration and a software configuration of the third embodiment is the same as those of the first and second embodiments. In the third embodiment, a controller 100 executes a process in FIG. 16 instead of the process in FIG. 11 as a job execution process. Hereinafter, portions different from the first and second embodiments are mainly described, and other processes and configurations are substantially the same as those of the first embodiment.

As illustrated in FIG. 16, in the third embodiment, when destination information of a logged-in user may not be acquired in step S106, the controller 100 determines whether an acquisition error has occurred (step S302).

Here, the acquisition error is in a state in which destination information may not be acquired due to a certain error although the destination information of the user is stored in user information. In this state, for example, the user information is stored in a server apparatus 30, the controller 100 may not acquire destination information included in the user information due to an error in communication with the server apparatus 30. Furthermore, in this state, for example, the destination information included in the user information may not be acquired due to a reading error or the like of a storage 310.

Here, the controller 100 displays a confirmation message for the user (step S304). Then the controller 100 acquires a destination (step S108). Note that, when the process proceeds from step S304 to step S108, the destination information of the logged-in user is not acquired. At this time, the controller 100 acquires the destination of the user by a direct input performed by the user.

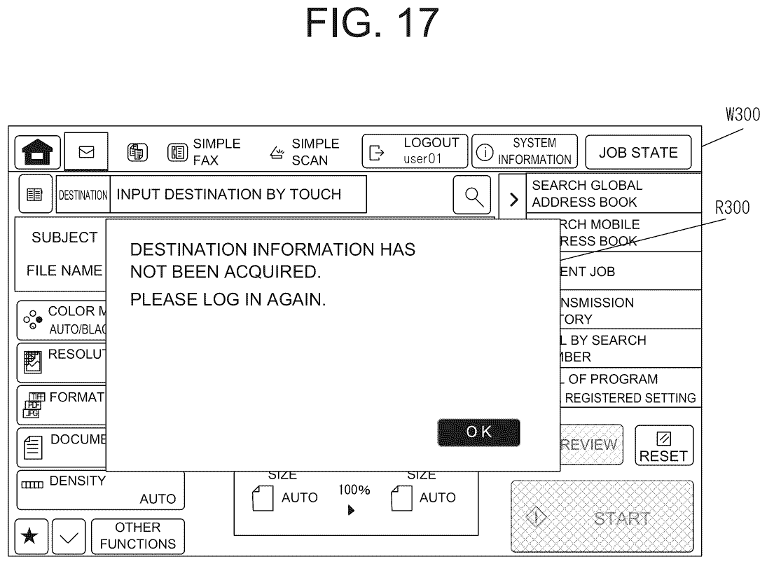

FIG. 17 is an example of a job execution screen W300. For example, the job execution screen W300 displays a confirmation message displayed in step S304 in a region R300. By this, the user can recognize that the destination information may not be acquired due to a certain error this time although the destination information has been set. Furthermore, the controller 100 may prompts the user to log in again. This is because there is a case where the controller 100 may acquire the destination information without an error when the user logs in again.

By this, the user can set a destination without restriction when the destination information may not be acquired due to a certain error although the destination information of the logged-in user has been set. Furthermore, the user sets only a restricted destination when the destination information of the logged-in user has not been set.

### 4. Fourth Embodiment

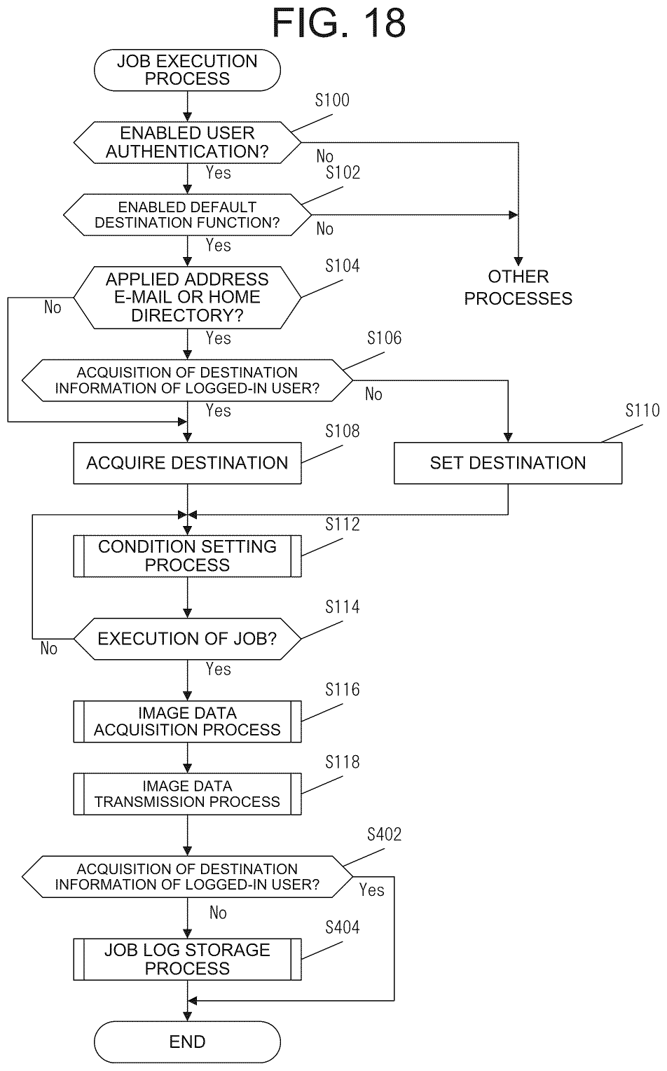

In a fourth embodiment, when destination information of a logged-in user may not be acquired, a log is stored. A hardware configuration and a software configuration of the fourth embodiment is the same as those of the first embodiment. In the fourth embodiment, a controller 100 executes a process in FIG. 18 instead of the process in FIG. 8 as a job execution process. Hereinafter, portions different from the first embodiment are mainly described, and other processes and configurations are substantially the same as those of the first embodiment.

After executing a job, that is, after an image data acquisition process and an image data transmission process are terminated (step S116 and step S118), the controller 100 determines whether destination information of a logged-in user may be acquired (step S402). The controller 100 may not acquire the destination information of the logged-in user in step S106, the controller 100 turns on a flag. Then the controller 100 may determine that the destination information of the logged-in user has not been acquired in step S402 when the flag is ON. Here, the flag is merely an example, and storage in an environmental file may be employed or storage in setting information of a system (for example, registry information or the like) may be employed. Furthermore, an identification file serving as a flag may be stored in a predetermined location, and the presence or absence of the file may be used for the determination instead of the flag.

Furthermore, the controller 100 may turn on the flag using a setting of a destination in step S110 as a trigger. Alternatively, when a destination is acquired in step S108 but the user changes the destination, the controller 100 may turn on the flag. Specifically, the ON state of the flag indicates that the destination information of the logged-in user is not used.

When the destination information of the logged-in user has not been acquired, the controller 100 executes a process of storing a job log (job log storage process) to store a log of a job (step S402; No→step S404).

Here, the controller 100 may store the log in a history data storage region 1140. The job log storage process stores the following logs.

### (1) Storage of Image Job Log

The controller 100 stores a log including a destination of a transmission, a date and time of the transmission, a user who has transmitted image data, and the transmitted image data. The image job log may also include a set condition.

### (2) Storage of Communication History

The controller 100 stores an address of a transmission destination as a log (history information). At this time, information relating to the logged-in user, information on the transmission destination (destination), and a date and time of the transmission may be stored as a log of the communication history. The communication history may be included in the image job log or other files.

In this way, according to this embodiment, when an image is transmitted in the state in which the destination information of the user may not be acquired, a log is stored. As a result, an administrator can check later whether there is unauthorized communication. In addition, by notifying the user that the log is stored, unauthorized use can be suppressed.

### 5. Fifth Embodiment

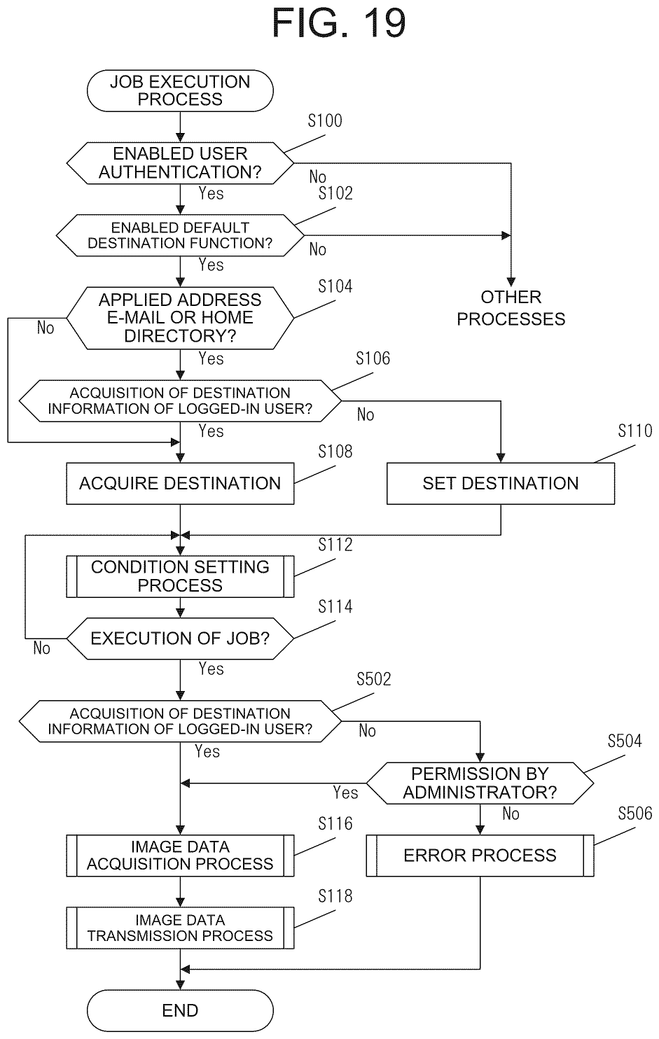

In a fifth embodiment, when destination information of a logged-in user may not be acquired, permission of an execution of a job by an administrator is confirmed. A hardware configuration and a software configuration of the fifth embodiment is the same as those of the first embodiment. In the fifth embodiment, a controller 100 executes a process in FIG. 19 instead of the process in FIG. 8 as a job execution process. Hereinafter, portions different from the first embodiment are mainly described, and other processes and configurations are substantially the same as those of the first embodiment.

When the job execution is selected (step S114; Yes), it is determined whether destination information of a logged-in user may be acquired (step S502). In step S502, as a method for determining whether destination information of a logged-in user may be acquired, the same method as that performed in step S402 of FIG. 18 may be used for the determination, and therefore, a description thereof is omitted.

Here, when destination information of a logged-in user may not be acquired, permission of an administrator may be requested (step S502; No→step S504). Without the permission of the administrator, the controller 100 may not execute a job but may execute an error process, for example, (step S504; No→step S506). Here, the controller 100 may execute a process of canceling a job, for example, as the error process.

The controller 100 executes a job when the permission of the administrator is acquired, for example (step S504: Yes→step S116).

Here, as a method for confirming the permission of the administrator, a function of transfer to the administrator may be used. The following describes use of the function of transfer to the administrator.

(1) A Job is Executed when Permission of the Administrator is Acquired.

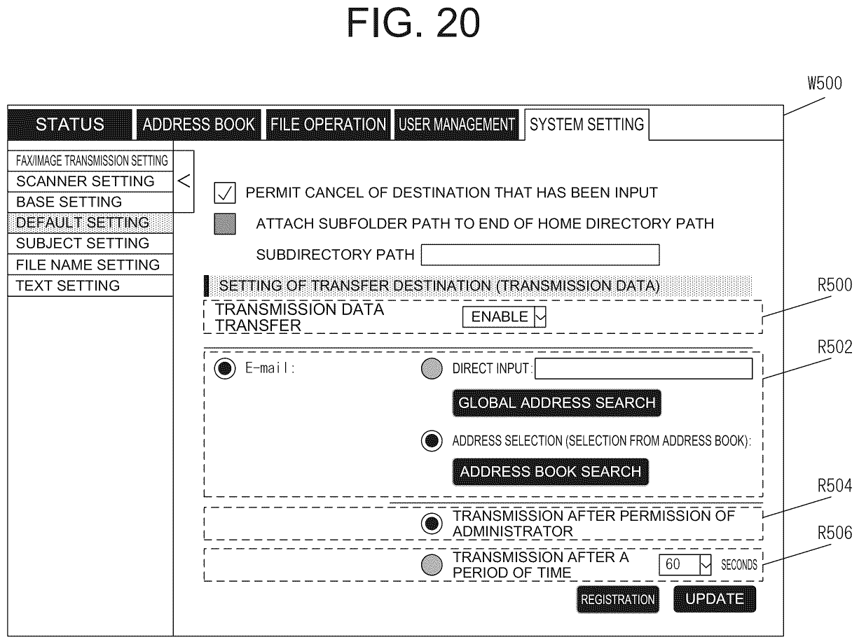

FIG. 20 is a diagram illustrating an example of a system setting screen W500 which accepts a setting of the function of transfer to the administrator. For example, a region R500 is used to set whether to enable or disable transfer of transmission data to the administrator (image data transmitted by executing a job). When “enable” is set in the region R500, the function of transfer to the administrator is enabled.

In a region R502, information on the administrator serving as a transfer destination is set. For example, an E-mail address or an account name may be designated as the administrator information.

In regions R504 and R506, operations to be performed by the administrator are set. For example, when the region R504 is turned on, the job executed by the user is temporarily in a standby state. Then, when the administrator gives a permission in a job state screen or the like, the job is executed.

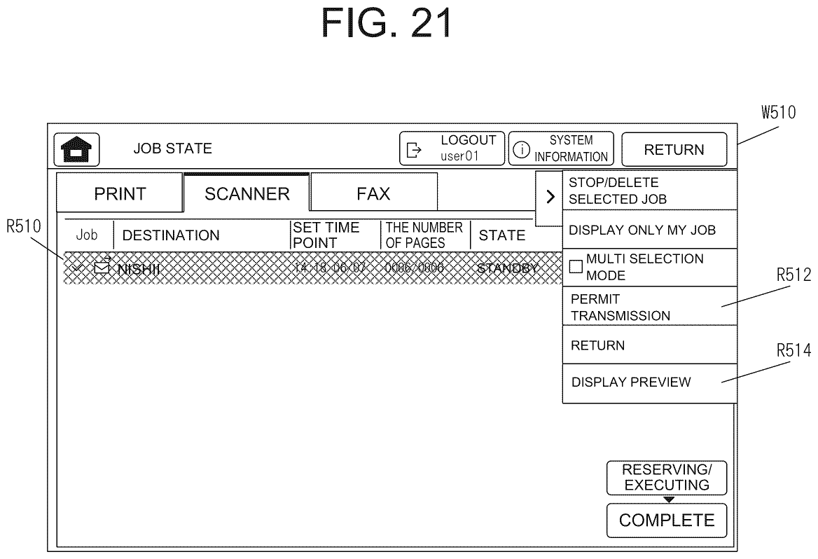

FIG. 21 is a diagram illustrating an example of a job state screen W510. For example, a job in a standby state is displayed in a region R510. For the job in the region R510, a time point (set time point) when the job is supplied and the number of pages included in the job to be executed are displayed. Furthermore, a state of the job is displayed in the region R510, and “standby” is displayed in FIG. 21.

When the administrator selects “permit transmission” in a region R512 after selecting a job to be permitted, the job is executed. Note that the controller 100 may prompt the administrator to input a password before executing the job. Furthermore, when the administrator selects “display preview” in a region R514 after selecting the job to be permitted, the controller 100 may display, as a preview, content of the job which has been executed. Since the preview is displayed, the administrator can confirm content of the job to be executed.

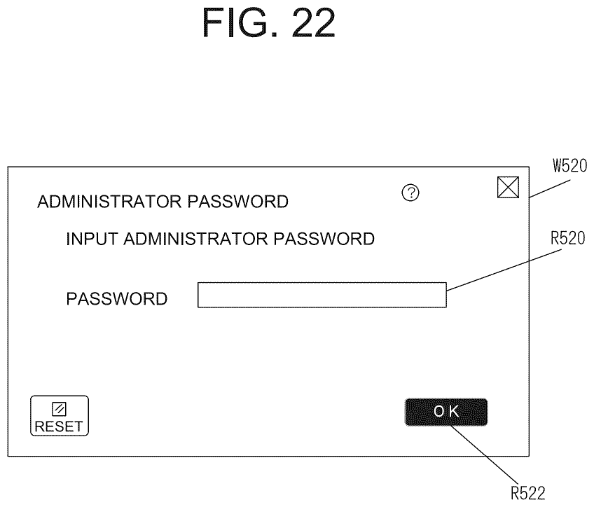

FIG. 22 is a diagram illustrating an example of a password input screen W520. A password input field R520 is displayed on the password input screen W520. The administrator inputs a password in the password input field R520 and selects an OK button displayed in a region R522. When the OK button is selected, the controller 100 performs password authentication.

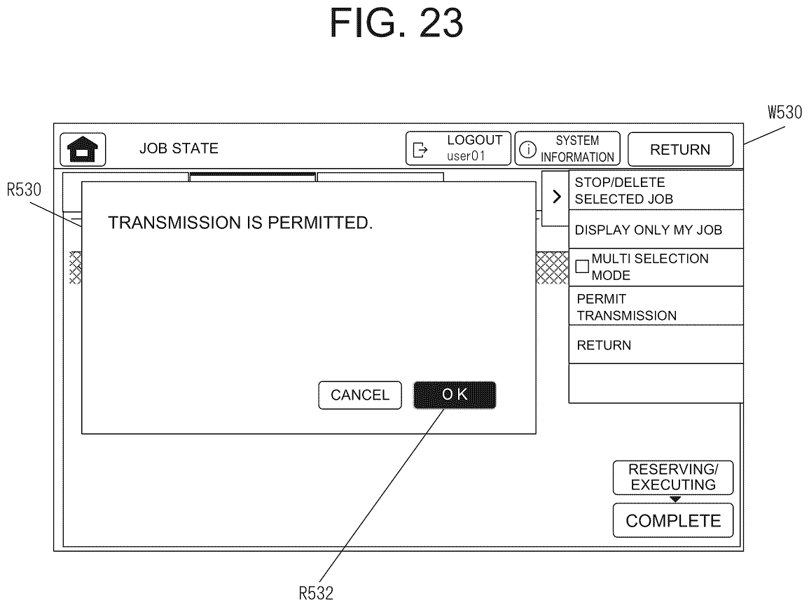

After the password authentication is successfully performed, the controller 100 executes a job. For example, in an example of a job state screen W530 in FIG. 23, a confirmation window is displayed in a region R530. When the administrator selects an OK button displayed in a region R532, the job is executed.

### (2) A Reserved Job is Executed.

A case where “transmission after a period of time” in the region R506 is selected in the system setting screen W500 of FIG. 20 will be described. When the user performs an operation for job execution, the job execution is reserved. For example, a period of time before transmission may be set in the region R506. For example, the period of time to be set may be selected from 10 seconds to 240 seconds at 10 second intervals. For example, “60 seconds” is set in the region R506 in FIG. 20. Therefore, the controller 100 suspends job execution once after the user instructs the job execution. Then, the controller 100 executes the job after 60 seconds has elapsed. Note that, during this time, the administrator may cancel the job execution.

### (3) A Notification of a Scanned Image is Transmitted to the Administrator.

Furthermore, as the function of transfer to the administrator, the controller 100 may perform a process of transmitting image data in the job execution to the administrator. For example, when transmitting image data to an E-mail address designated by the user, the controller 100 transmits the image data also to an address of the administrator. At this time, the controller 100 may add the E-mail address of the administrator in a setting of so-called blind carbon copy (Bcc) and transmit the image data.

### (4) The Above Processes are Combined.

Furthermore, the controller 100 may combine the processes described above. For example, even when it is set that permission of the administrator is required before transmission, the transmission may be performed after a predetermined period of time in a case of a specific domain (that is, the permission of the administrator is not required). Furthermore, when the administrator does not give the permission for the predetermined period of time, the controller 100 may execute the job. Furthermore, when the job is executed without permission of the administrator, the controller 100 may transmit image data to the administrator. Moreover, when the administrator gives the permission, the controller 100 may request transmission of image data.

### 6. Sixth Embodiment

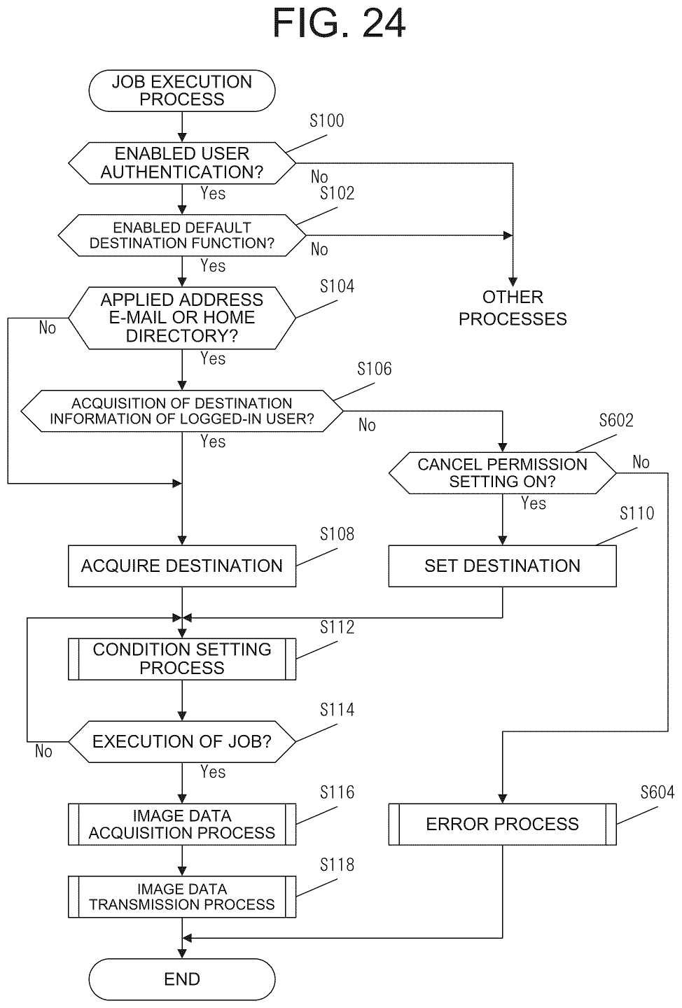

In a sixth embodiment, when a user may cancel (change) an address of a transmission destination set in advance by a controller 100, a destination may be input even if destination information of the user may not be acquired. A hardware configuration and a software configuration of the sixth embodiment is the same as those of the first embodiment. In the sixth embodiment, the controller 100 executes a process in FIG. 24 instead of the process in FIG. 8 as a job execution process. Hereinafter, portions different from the first embodiment are mainly described, and other processes and configurations are substantially the same as those of the first embodiment.

The controller 100 determines whether a cancel permission setting is “ON” when destination information of a logged-in user may not be acquired in step S106 of FIG. 24 (step S602).

The controller 100 reads the cancel permission setting with reference to a system setting stored in a system setting storage region 1110. Furthermore, the cancel permission setting may be made, for example, in a system setting screen W100 of FIG. 5. The cancel permission setting is made in a region R104 of the system setting screen W100. In the region R104, ON/OFF of an item of “permit cancel of destination that has been input” may be switched from one to another. When a destination that has been input is canceled, the controller 100 deletes the destination information of the logged-in user which is set as the destination. Accordingly, the user may input an arbitrary destination.

Referring back to FIG. 24, in a system setting, when the cancel permission setting is “ON”, a destination may be set even if the destination information of the logged-in user may not be acquired (step S602; Yes→step S110). Furthermore, in the system setting, when the cancel permission setting is “OFF”, the controller 100 executes an error process (step S604).

Here, when executing the error process, the controller 100 may display a fact that a process may not be executed or may display a message “a destination may not be selected” in a region of a destination selection.

By this, according to this embodiment, in a case where destination information of a logged-in user may not be acquired, the user can set a destination only when a setting of the destination cancel permission is enabled.

Note that, according to this embodiment, in a destination setting in step S110, a default destination may be acquired instead of a destination setting performed by the user. For example, the controller 100 may acquire destination information remaining in an internal cache of an image forming apparatus 10 and set the destination information.

It is assumed that the controller 100 may not acquire the destination information due to an error although the destination information of the logged-in user has been set. In this case, when destination information acquired before is stored in the cache, the controller 100 may set a destination serving as a transmission destination based on the destination information.

Furthermore, when the logged-in user stores a transmission destination address of image data which was previously transmitted as history, the transmission destination address stored as the history may be used.

Moreover, when the destination information is acquired from the cache or the history, the fact may be displayed. The user can recognize that a currently set destination is acquired from the cache or the history. As a result, the user can easily recognize that appropriate destination information has not been acquired, and therefore, a process of performing a login again may be executed.

### 7. Seventh Embodiment

In a seventh embodiment, when a controller 100 may not acquire destination information of a logged-in user and when the user set a destination, a confirmation screen for confirming a destination (E-mail address or a directory) is displayed. The seventh embodiment may be combined with any of the foregoing embodiments, and a combination with the first embodiment will now be described as an example.

For example, in the first embodiment in FIG. 8, a destination is input in step S110. Here, the controller 100 may store a fact that the destination information of the logged-in user has not been acquired.

The controller 100 may display a confirmation screen for confirming a transmission destination when executing an image data transmission process (step S118). Here, the controller 100 may display the confirmation screen for confirming a destination of transmission when the destination information of the logged-in user may not be acquired.

Furthermore, the controller 100 acquires a destination from destination information of a logged-in user in step S108 and sets the destination as a default destination. Thereafter, the controller 100 may display a confirmation screen for confirming a destination of transmission in step S118 when the destination is changed by the user. Specifically, the controller 100 may display a confirmation screen for confirming a transmission destination when a destination included in the destination information of the logged-in user is different from the destination information set when the job is executed.

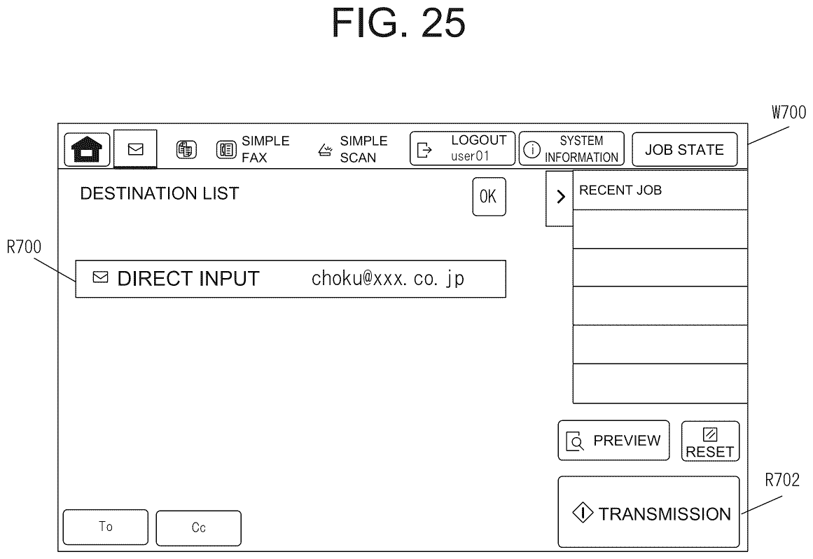

FIG. 25 is a diagram illustrating an example of a confirmation screen W700. For example, a region R700 indicates that a destination is directly input, and an E-mail address directly input by the user is displayed.

The user selects a transmission confirmation button displayed in a region R702 when the destination is appropriate. The controller 100 executes a job when the user selects the transmission confirmation button. For example, the controller 100 executes an image data transmission process (step S118) to transmit read image data to the destination.

### 8. Modifications

The present disclosure is not limited to the embodiments described above, and various modifications may be made.

That is, the technical scope of the present disclosure also includes such embodiments that can be obtained by combining technical measures that are modified as appropriate within a range not departing from the gist of the present disclosure.

In the above-described embodiments, the image forming apparatuses are described as examples of an information processing apparatus. However, the present disclosure is applicable to other apparatuses as the information processing apparatus. Examples of the information processing apparatus include a smartphone and a tablet terminal. The examples further include a home appliance (such as an air conditioner, a refrigerator, or a television set) equipped with an IoT function. Furthermore, the examples are not limited to stationary apparatuses, and further include a portable apparatus and an in-vehicle apparatus. Examples of the in-vehicle apparatus include a car navigation system.

Furthermore, although the above-described embodiments are individually described for convenience of explanation, the embodiments may be executed in combination within a possible range. Moreover, the applicant intends to acquire rights to any of the technologies described in the specification through amendments, divisional applications, and the like.

Furthermore, programs that run on each device in each embodiment control the CPU and the like (programs that cause a computer to function) so as to achieve the functions of the above-described embodiments. Moreover, information handled by these devices is temporarily stored in a temporary storage device (for example, a RAM) when being processed, and then stored in various storage devices, such as a ROM and an HDD, where the information is read, corrected, and written by the CPU as needed.

Here, a recording medium for storing the programs may be any of a semiconductor medium (e.g., a ROM, a non-volatile memory card, etc.), an optical recording medium/magneto-optical recording medium (e.g., a Digital Versatile Disc (DVD), a CD (Compact Disc), a BD (Blu-ray registered trademark), etc.), a magnetic recording medium (e.g., a magnetic tape, a flexible disc, etc.), and the like.

Furthermore, in a case where the programs are to be distributed to the market, the programs may be stored in a portable recording medium for distribution or transferred to a server computer connected via a network, such as the Internet. In this case, of course, a storage device in a server apparatus is also included in the present disclosure.

Furthermore, the data described above may not be stored in the device, but may be stored in an external device and called as appropriate. For example, the data may be stored in a Network Attached Storage (NAS) or on the cloud.

Note that the scope of the present disclosure is not limited to the configurations explicitly described in the specification but includes any combination of the technologies disclosed in the present specification. In the present disclosure, the configurations to be patented are described in the appended claims. However, it is not intended to exclude configurations from the technical scope on the grounds that the configurations are not described in the claims.

In addition, the descriptions “in a/the case of/where” and “when” in the specification are explained as examples, and the configuration is not limited to the described contents. Configurations other than the cases described with “in a/the case of/where” and “when” are also disclosed to the extent that would be obvious to a person skilled in the art, and it is intended to acquire the right to such configurations.

Furthermore, the order of processing and the data flow described in the specification is not limited to the order in which they are described. For example, a configuration in which a part of processing is removed, or the order thereof is switched is also disclosed, and it is intended to acquire the right to such a configuration.

The functions described in the embodiments are described as being performed by the corresponding devices, but they may be realized by a single device or even by using an external server.

Moreover, the functional blocks or various features of the apparatuses used in the above-described embodiments may be implemented or executed as an electrical circuit, such an integrated circuit or a plurality of integrated circuits. The electric circuit designed to execute the functions described in the present specification may include a general-purpose processor, a digital signal processor (DSP), an application-specific integrated circuit (ASIC), a field-programmable gate array (FPGA) or other programmable logic devices, a discrete gate or transistor logic, discrete hardware components, or a combination of the aforementioned elements. The general-purpose processor may be a microprocessor or, alternatively, a conventional processor, a controller, a microcontroller, or a state machine. The electric circuit described above may be constituted by a digital circuit or by an analog circuit. In the case where an integrated circuit technology that replaces the current integrated circuit emerges as a result of advances in the semiconductor technology, one or more aspects of the present disclosure can also use a new integrated circuit based on such technology.

What is claimed is:

1. An image forming apparatus, comprising:
one or more memories that store user information including destination information, associated with one or more users;
an authenticator that authenticates a login of any one of the one or more users with reference to the user information;
an acquirer that acquires the destination information associated with the logged-in user from the user information; and
one or more controllers that are capable of executing a transmission process with the acquired destination information as a transmission destination when the destination information associated with the logged-in user is acquired from the user information, wherein
the one or more controllers execute the transmission process by accepting a setting of the transmission destination from the logged-in user, even when the destination information associated with the logged-in user is not acquired from the user information.

2. The image forming apparatus according to claim 1, wherein
when the acquirer does not acquire the destination information, the one or more controllers set a restriction on a setting of the transmission destination in comparison with a case where the destination information is acquired.

3. The image forming apparatus according to claim 2, wherein
the one or more controllers set a restriction to prohibit an acceptance of an input of the transmission destination in the setting of a transmission destination.

4. The image forming apparatus according to claim 3, wherein
the one or more controllers set a restriction to only allow a specific transmission destination to be set on the setting of a transmission destination.

5. The image forming apparatus according to claim 4, wherein
the one or more memories further store information on a transmission destination as an address book, and
the specific transmission destination is stored in the address book.

6. The image forming apparatus according to claim 2, wherein
as the restriction of a transmission destination, a restriction to only allow a transmission destination including a specific character string to be set is set.

7. The image forming apparatus according to claim 6, wherein
the specific character string represents a domain name or a folder path.

8. The image forming apparatus according to claim 1, wherein
the acquirer acquires the destination information from a management server, and
when the destination information is not acquired due to an error of communication with the management server, no restriction is set on the setting of a transmission destination.

9. The image forming apparatus according to claim 1, wherein
the one or more controllers
perform a confirmation request at a time of execution of the transmission process when the transmission destination is set, and
execute the transmission process when a response indicating permission for the confirmation request is received.

10. The image forming apparatus according to claim 1, wherein
the one or more controllers store content of the execution of the transmission process as a log when the transmission destination is set.

11. The image forming apparatus according to claim 1, wherein
the one or more controllers determine whether to accept a setting of a transmission destination from the logged-in user, based on a setting as to whether the transmission destination is changeable, when the destination information associated with the logged-in user is not acquired from the user information.

12. The image forming apparatus according to claim 11, wherein
the one or more controllers accept the setting of a transmission destination from the user when the setting indicates that the transmission destination is changeable.

13. The image forming apparatus according to claim 11, wherein
the acquirer acquires, as the destination information, information indicating a default transmission destination when the transmission function is executed, and
the one or more controllers accept, when the set default transmission destination is cancellable, the transmission destination set by the user, thereby executing the transmission process.

14. The image forming apparatus according to claim 11, wherein
the one or more memories further store, as a history, destination information when the transmission process is executed, and
the one or more controllers set the destination information stored in the one or more memories as a transmission destination when the destination information is not acquired by the acquirer and the transmission destination is changeable.

15. A process executing method employed in an image forming apparatus, comprising:
storing user information including destination information, associated with one or more users;
authenticating a login of any one of the one or more users with reference to the user information;
acquiring the destination information associated with the logged-in user from the user information; and
by accepting a setting of a transmission destination from the logged-in user, executing a transmission process with respect to the transmission destination, even when the destination information associated with the logged-in user is not acquired from the user information.
